(19) United States
(12) Patent Application Publication
(10) Pub. No.: US 2005/0087912 A1
(43) Pub. Date: Apr. 28, 2005

(54) Method for forming objects

(76) Inventors: Sheng-Jye Hwang, Tainan (TW); Cheng-Chien Wang, Tainan Hsien (TW); Sen-Yung Lee, Tainan City (TW); Muh-Rong Wang, Tainan City (TW); Chun-S. Wang, Tainan (TW); Chuh-Yung Chen, Tainan (TW); Chieh-Li Chen, Tainan (TW); Wei-Hsiang Lai, Tainan (TW); Chen Hsieh, Tainan (TW); Tsong-Shyng Leu, Tainan (TW); Chun-I Cheng, Kaohsiung Heien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/692,813

(22) Filed: Oct. 27, 2003

(51) Int. Cl. B29C 35/08

(52) U.S. Cl. 264/497; 264/401; 264/409

(57) ABSTRACT

A method for forming objects includes a step of spreading base material on a limited area by nozzles or rollers, step of proceeding a first time of physical or chemical change on selected areas by heating boards, ultra violet beams or infra-red beams so as to have gel-like material, and step of selectively proceeding a second time of physical or chemical change by laser beam or adding additional material on the selected areas of the base material so that the nature of the gel-like material becomes acceptable. The gel-like material is laminated to build a three dimensional object.

### FIELD OF THE INVENTION

The present invention relates to a method for forming objects and is used on rapid prototyping process. The method relates to the manufacture of an object with three dimensions by using two-time reaction so as to save time, cost and increase level of precision.

### BACKGROUND OF THE INVENTION

A conventional method for making a prototype of a product employs CNC which cooperates with blades, molds and chuck to make the prototype. In other words, the method using CNC is very much limited by the blades, molds and chuck.

There are several rapid prototyping techniques developed such as SLA as shown in FIGS, 1 and 2, SLA (Stereolithography) as shown in FIGS. 3, FDM as shown in FIG. 4, 3DP as shown in FIG. 5, LOM, OBJet, and CLF (Ceramic Laser Fusion). SLA employs He—Cd or Ar ultraviolet laser beam by galvanometer mirror onto the resin which then forms a thin surface layer about 0.15-0.05 mm in thickness. The Z axle is then lowered to spread a liquid layer of polymer on the position where to be machined. A scraper is used to break the surface tension so as to remove the liquid layer and keeps the surface to be horizontal. The laser beam scans the horizontal surface to bind the two layers. A solid and three-dimension product is then obtained by repeating the processes. Nevertheless, this method requires a support and all the resin are in liquid form which occupies too much space and involves high manufacturing cost.

The SLS employs laser to sinter the resin powder which then binds with the base material on the surface of the prototype. The Z axle is lowered to spread a filament of powder and repeat the sintering process by using laser beam to obtain the prototype. It is noted that the powder is not spread evenly by using the scraper or roller and it consumes a lot of time to pre-heat the power of the base material. The powder could be inhaled by the workers to harm their lungs. The powder is not suitable to be heated evenly so that it is difficult to make large piece of object by this method.

3DP builds a layer of powder and adherent is spread on the selected areas by injection technique such that the powder becomes the outer surface of the prototype. A complete prototype can be obtained by repeating the processes. As expected, the powder is difficult to be spread evenly on a surface and only some type of material can be chosen to be the base material. The precision of the injection machine has to be controlled at a highly precise condition and this increases the difficulties of the method.

LOM cuts a solid material by laser beam into thin layers which are then combined by adherent. The main problem is that extra material is difficult to be removed.

OBJet uses two different materials, one of which is the base material and the other one is used to build a support. The two materials are treated by ultraviolet beam and become gel-like material so as to be combined with each other. A final prototype can be obtained by repeating the processes. The precision of the nozzle to spread the material decides the final result and it requires frequent cleaning to the nozzle.

CLF adds inorganic binder and dissolving agent into the ceramic powder so as to become a plastic mixture. The mixture is mopped to be a flat layer and heated to be a dehydrated layer. The dehydrated layer is then hardened by laser beam at desired areas and is much harder than it is simply dehydrated. This method is not suitable to be used for making prototype.

### SUMMARY OF THE INVENTION

In accordance with one aspect of the present invention, there is provided a method for forming objects and the method comprises the following steps:
step 1: spreading base material on a limited area by proper methods or tools;
step 2: proceeding a first time of physical or chemical change on selected areas by changes of temperature, ultra violet beams or infra-red beams to make the base material become gel-like material, and
step 3: selectively proceeding a second time of physical or chemical change by laser beam or adding additional material on the selected areas of the base material and a nature of the gel-like material becoming acceptable.

Laminating the layers of the material in step 3 repeatedly to build a three dimensional object. The material that is not proceeded by the second time of physical or chemical change can be retrieved or removed.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the classification of the rapid prototyping;

FIG. 2 shows the method of SLA;

FIG. 3 shows the method of SLS;

FIG. 4 shows the method of FDM;

FIG. 5 shows the method of 3DP;

FIG. 6 shows the steps of the method of the present invention;

FIG. 7 shows the steps of the first embodiment of the method of the present invention;

FIG. 8 shows the steps of the second embodiment of the method of the present invention;

FIG. 9 shows the steps of the third embodiment of the method of the present invention;

FIG. 10 shows the steps of the fourth embodiment of the method of the present invention;

FIG. 11 shows the steps of the fifth embodiment of the method of the present invention;

FIG. 12 shows the steps of the sixth embodiment of the method of the present invention;

FIG. 13 shows the steps of the seventh embodiment of the method of the present invention;

FIG. 14 shows the steps of the eighth embodiment of the method of the present invention;

FIG. 15 shows the steps of the ninth embodiment of the method of the present invention;

FIG. 16 shows the steps of the tenth embodiment of the method of the present invention, and

FIG. 17 shows the steps of the eleventh embodiment of the method of the present invention.

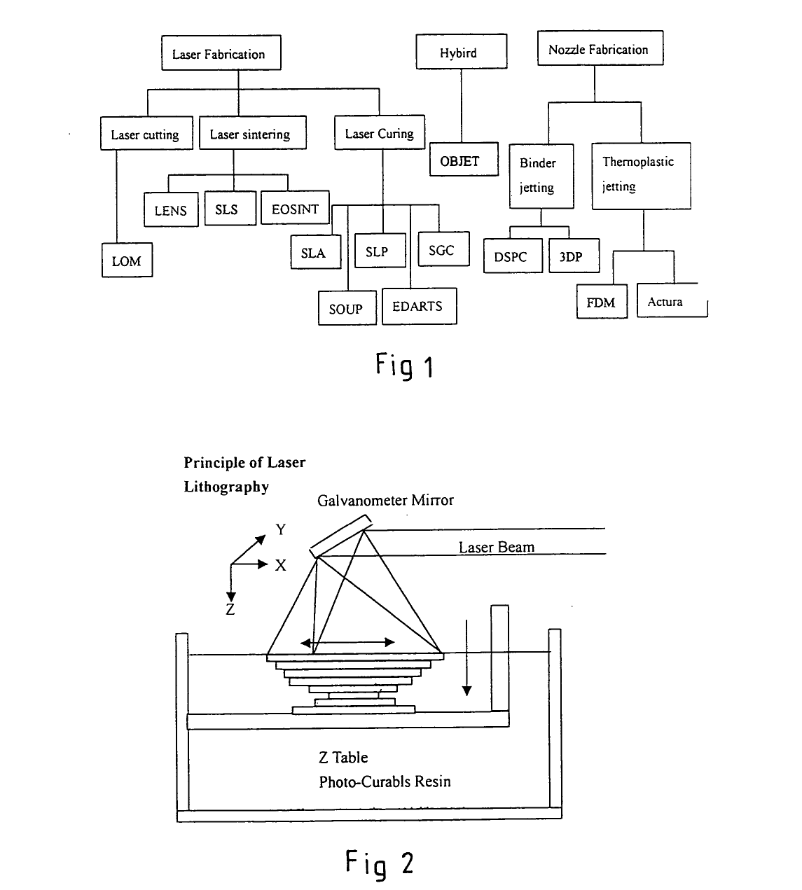

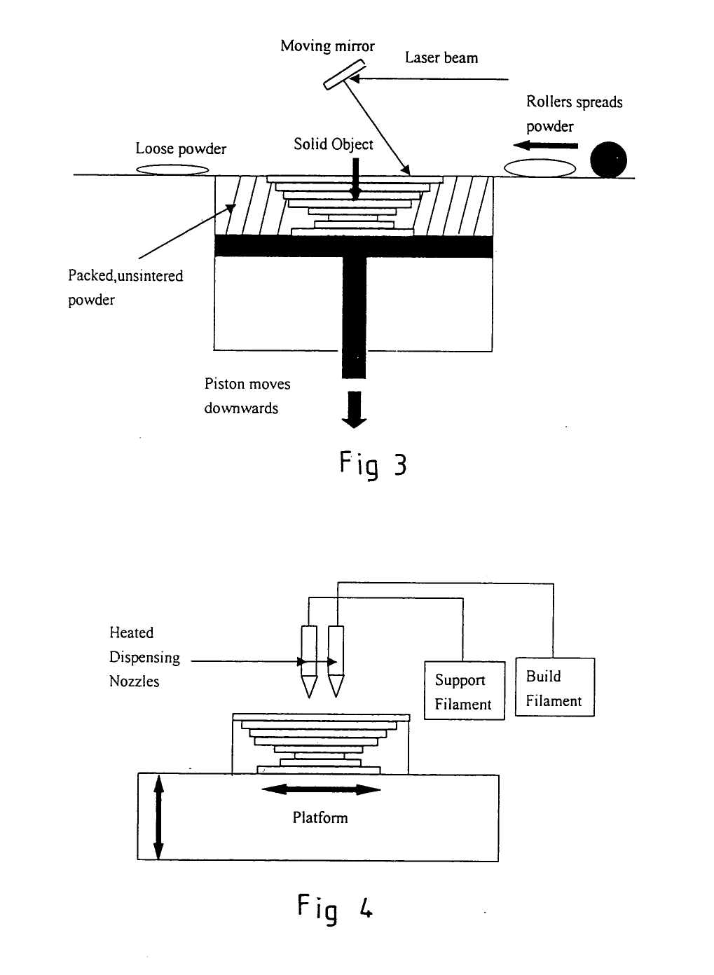

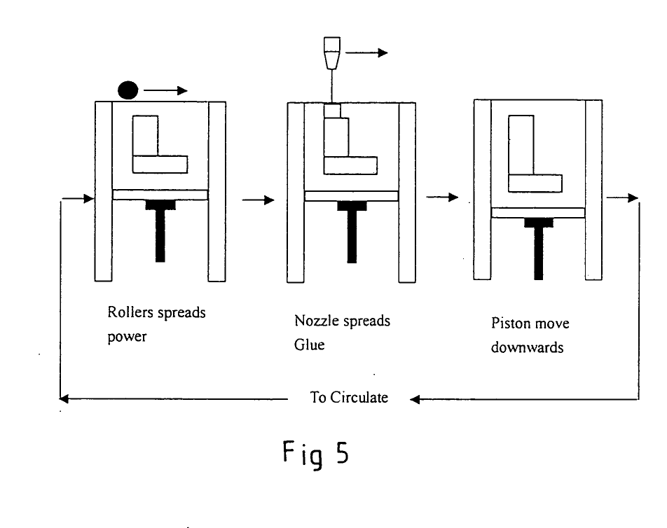

### DETAILED DESCRIPTION OF THE PREFERRED EMBODIMENT

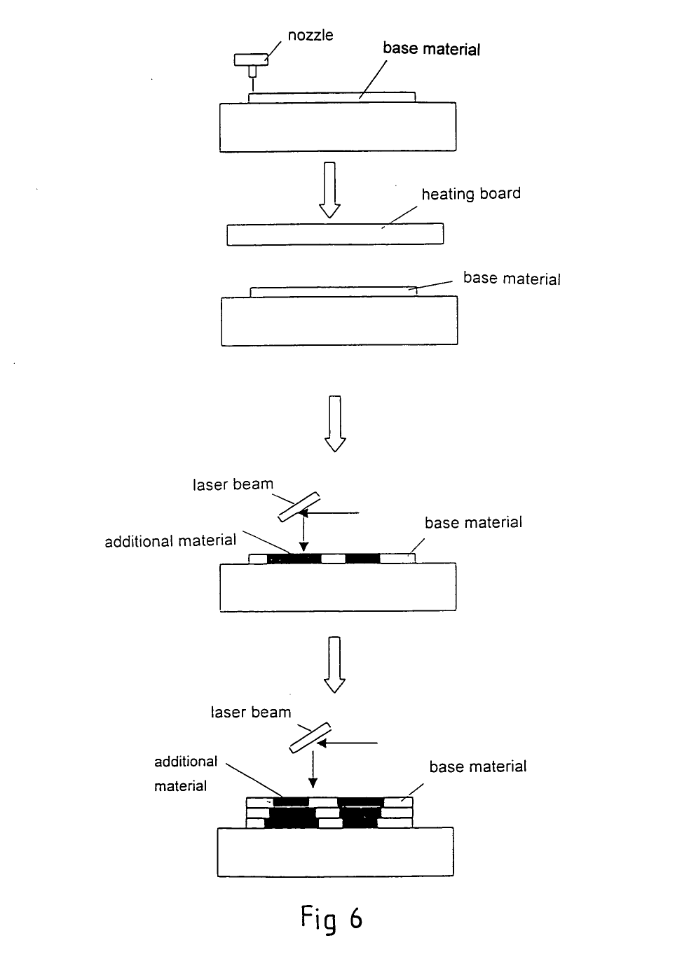

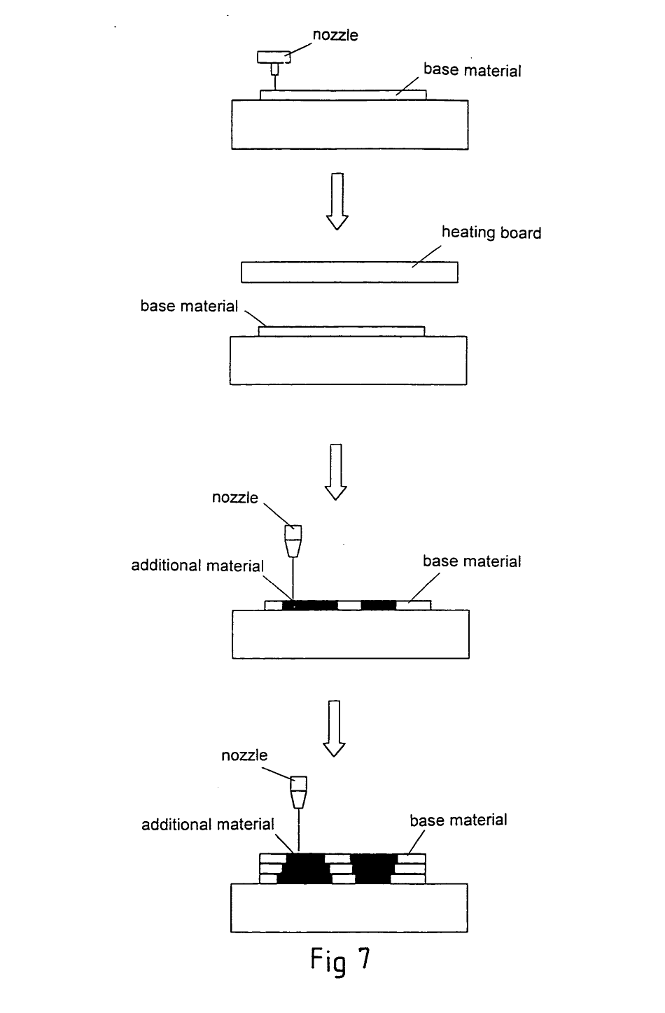

Referring to FIG. 6, the method of the present invention comprises:
step 1: preparing base material which is rolled or spread to be a flat and even thin layer;
step 2: using difference of temperature, ultra violet beam, infra red beam, or spreading a coating to make the thin layer in step 1 to have a fist time of physical or chemical change;
step 3: adding other material by using laser scanning or nozzle injection at selected areas to have a second time of physical or chemical change;
step 4: repeating steps 1-3 and removing material that is not affected during the two times of physical or chemical change, till a prototype is obtained.

As shown in FIG. 7 which is a first embodiment of the method and includes the following steps:
step 1: spreading the base material on a limited area to be a flat surface by nozzles;
step 2: proceeding the first time of physical or chemical change by the difference of temperature of the heating board;
step 3: adding additional material to the base material so as to make the base material proceed second time of physical or chemical change;
step 4: repeating steps 1-3 pre-determined times which are the number of layers of the two dimensional areas cut from the solid object, and building connection between the layers;
step 5: removing the base material after the first time of physical or chemical change from the result after the second time of physical or chemical change so as to obtain the final prototype.

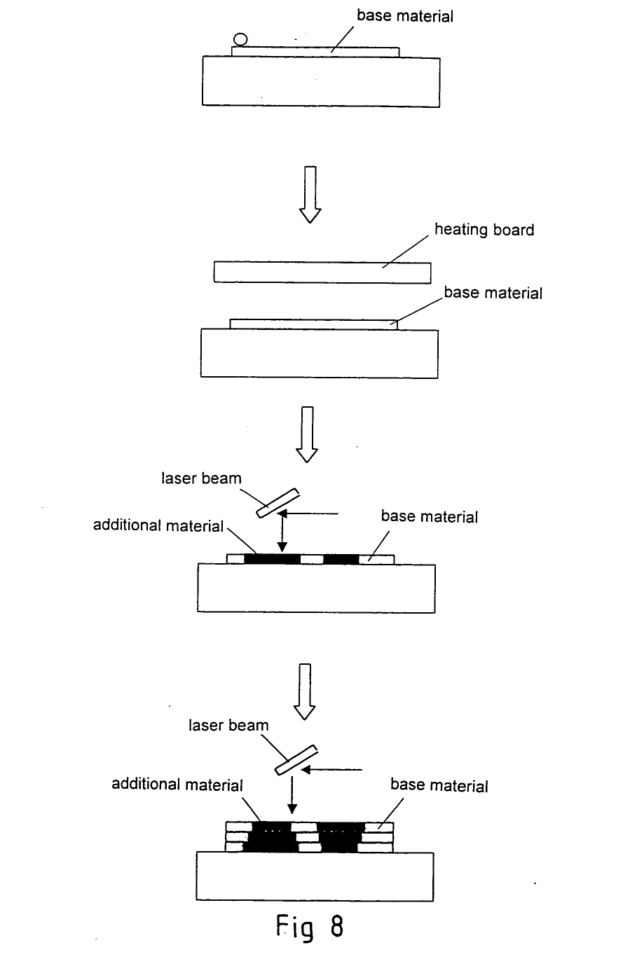

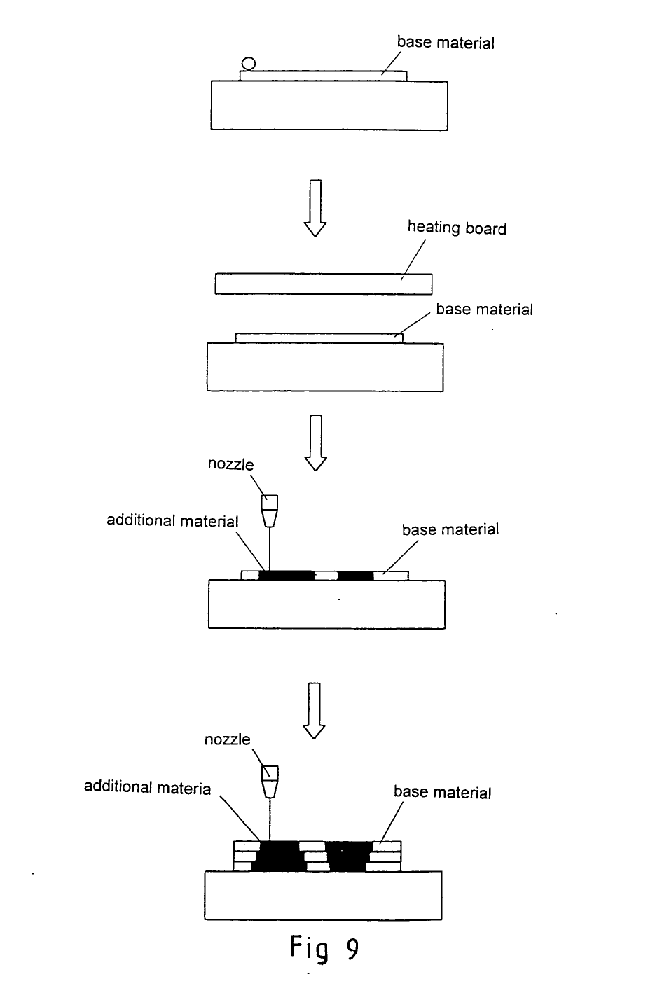

As shown in FIG. 8 which is a second embodiment of the method and includes the following steps:
step 1: spreading the base material on a limited area to be a flat surface by rollers;
step 2: proceeding the first time of physical or chemical change by the difference of temperature of the heating board;
step 3: selectively proceeding the second time of physical or chemical change by laser beam on the selected areas of the base material;
step 4: repeating steps 1-3 pre-determined times which are the number of layers of the two dimensional areas cut from the solid object, and building connection between the layers;
step 5: removing the base material after the first time of physical or chemical change from the result after the second time of physical or chemical change so as to obtain the final prototype.

As shown in FIG. 9 which is a third embodiment of the method and includes the following steps:
step 1: spreading the base material on a limited area to be a flat surface by rollers;
step 2: proceeding the first time of physical or chemical change by the difference of temperature of the heating board;
step 3: adding additional material to the base material so as to proceed the second time of physical or chemical change for the base material;
step 4: repeating steps 1-3 pre-determined times which are the number of layers of the two dimensional areas cut from the solid object, and building connection between the layers;
step 5: removing the base material after the first time of physical or chemical change from the result after the second time of physical or chemical change so as to obtain the final prototype.

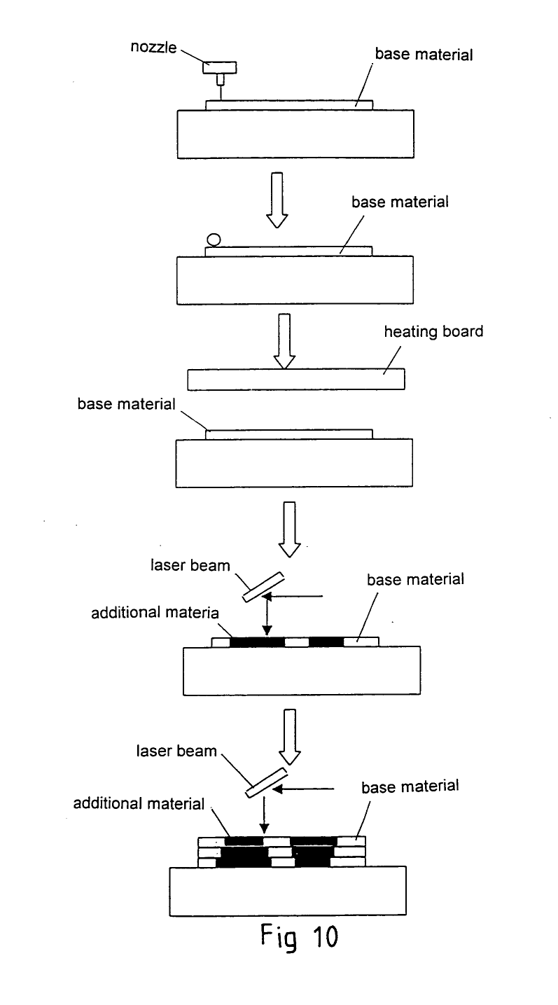

As shown in FIG. 10 which is a fourth embodiment of the method and includes the following steps:
step 1: spreading the base material on a limited area by nozzles and rolling the limited area to be a flat surface by rollers;
step 2: proceeding the first time of physical or chemical change by the difference of temperature of the heating board;
step 3: selectively proceeding the second time of physical or chemical change by laser beam on the selected areas of the base material;
step 4: repeating steps 1-3 pre-determined times which are the number of layers of the two dimensional areas cut from the solid object, and building connection between the layers;
step 5: removing the base material after the first time of physical or chemical change from the result after the second time of physical or chemical change so as to obtain the final prototype.

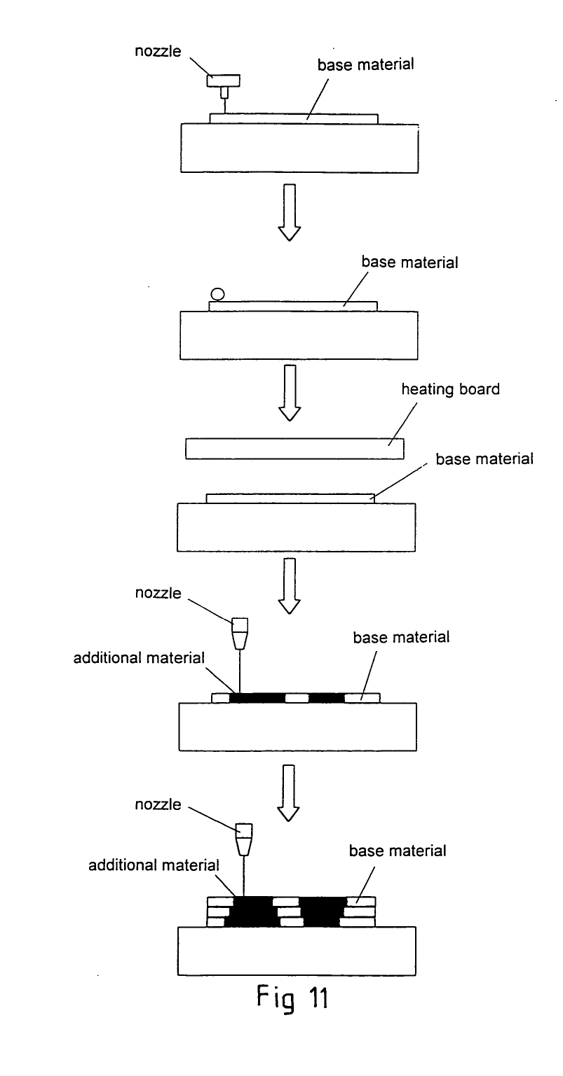

As shown in FIG. 11 which is a fifth embodiment of the method and includes the following steps:
step 1: spreading the base material on a limited area by nozzles and rolling the limited area to be a flat surface by rollers;
step 2: proceeding the first time of physical or chemical change by the difference of temperature of the heating board;
step 3: adding additional material to the base material so as to proceed the second time of physical or chemical change for the base material;
step 4: repeating steps 1-3 pre-determined times which are the number of layers of the two dimensional areas cut from the solid object, and building connection between the layers;
step 5: removing the base material after the first time of physical or chemical change from the result after the second time of physical or chemical change so as to obtain the final prototype.

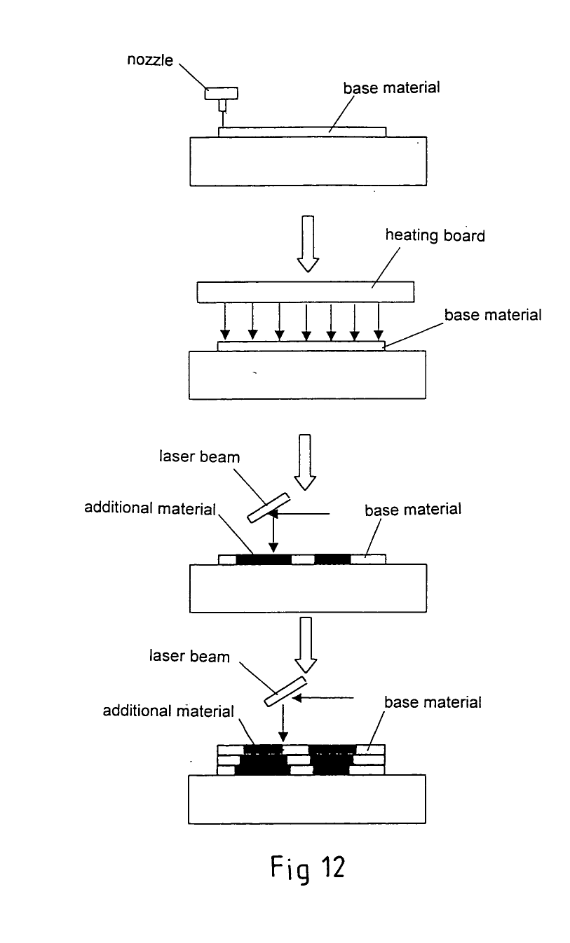

As shown in FIG. 12 which is a sixth embodiment of the method and includes the following steps:
step 1: spreading the base material on a limited area by nozzles;
step 2: proceeding the first time of physical or chemical change on the selected areas by the ultra violet beams or infra-red beams;
step 3: selectively proceeding the second time of physical or chemical change by laser beam on the selected areas of the base material;
step 4: repeating steps 1-3 pre-determined times which are the number of layers of the two dimensional areas cut from the solid object, and building connection between the layers;
step 5: removing the base material after the first time of physical or chemical change from the result after the second time of physical or chemical change so as to obtain the final prototype.

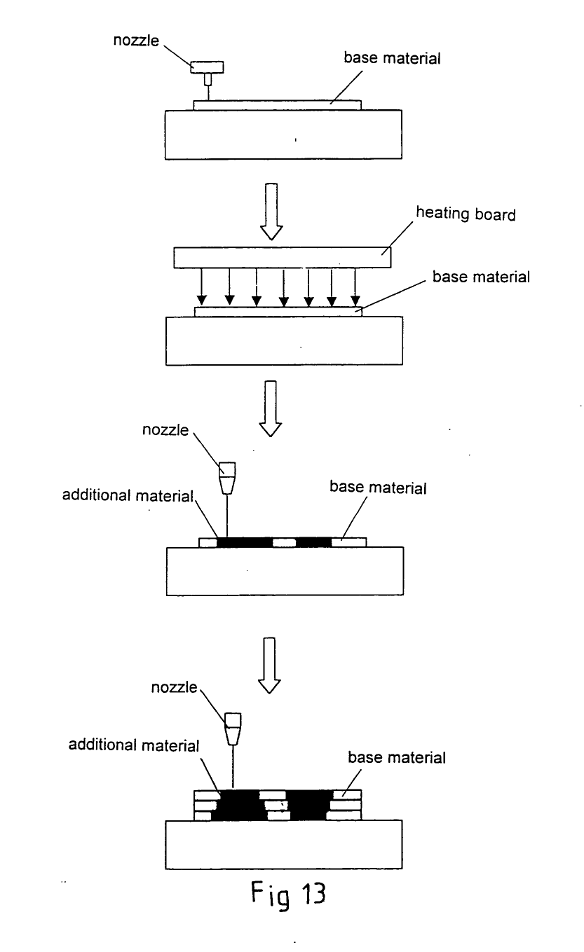

As shown in FIG. 13 which is a seventh embodiment of the method and includes the following steps:
step 1: spreading the base material on a limited area by nozzles;
step 2: proceeding the first time of physical or chemical change on the selected areas by the ultra violet beams or infra-red beams;
step 3: adding additional material to the base material so as to proceed the second time of physical or chemical change for the base material;
step 4: repeating steps 1-3 pre-determined times which are the number of layers of the two dimensional areas cut from the solid object, and building connection between the layers;
step 5: removing the base material after the first time of physical or chemical change from the result after the second time of physical or chemical change so as to obtain the final prototype.

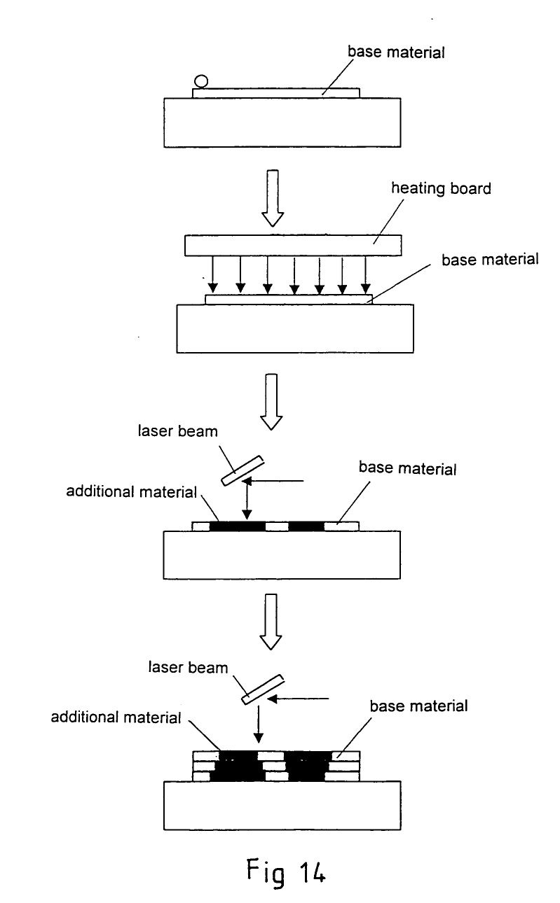

As shown in FIG. 14 which is an eighth embodiment of the method and includes the following steps:
step 1: spreading the base material on a limited area by rollers;
step 2: proceeding the first time of physical or chemical change on the selected areas by the ultra violet beams or infra-red beams;
step 3: selectively proceeding the second time of physical or chemical change by laser beam on the selected areas of the base material;
step 4: repeating steps 1-3 pre-determined times which are the number of layers of the two dimensional areas cut from the solid object, and building connection between the layers;
step 5: removing the base material after the first time of physical or chemical change from the result after the second time of physical or chemical change so as to obtain the final prototype.

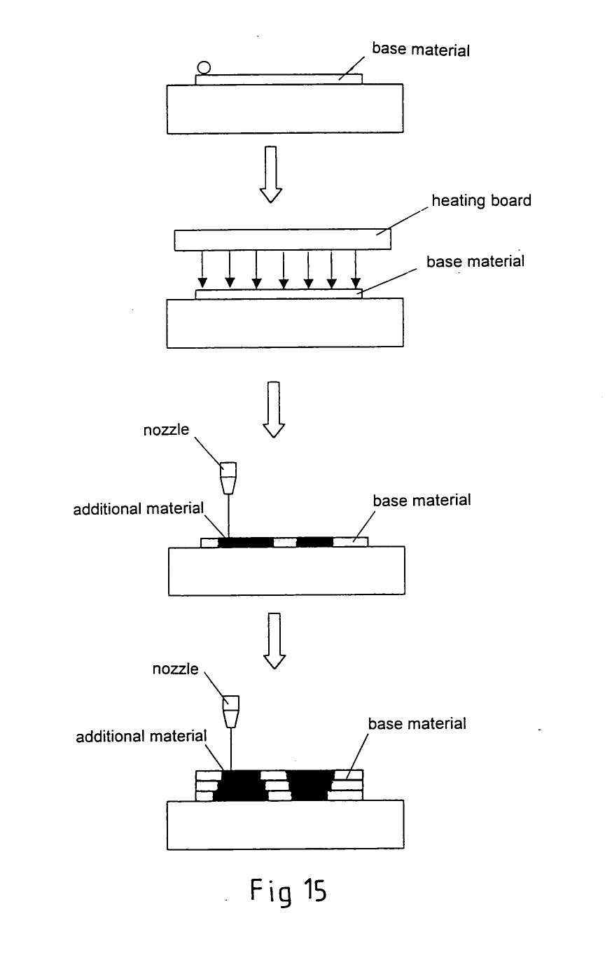

As shown in FIG. 15 which is a ninth embodiment of the method and includes the following steps:
step 1: spreading the base material on a limited area by rollers;
step 2: proceeding the first time of physical or chemical change on the selected areas by the ultra violet beams or infra-red beams;
step 3: adding additional material to the base material so as to proceed the second time of physical or chemical change for the base material;
step 4: repeating steps 1-3 pre-determined times which are the number of layers of the two dimensional areas cut from the solid object, and building connection between the layers;
step 5: removing the base material after the first time of physical or chemical change from the result after the second time of physical or chemical change so as to obtain the final prototype.

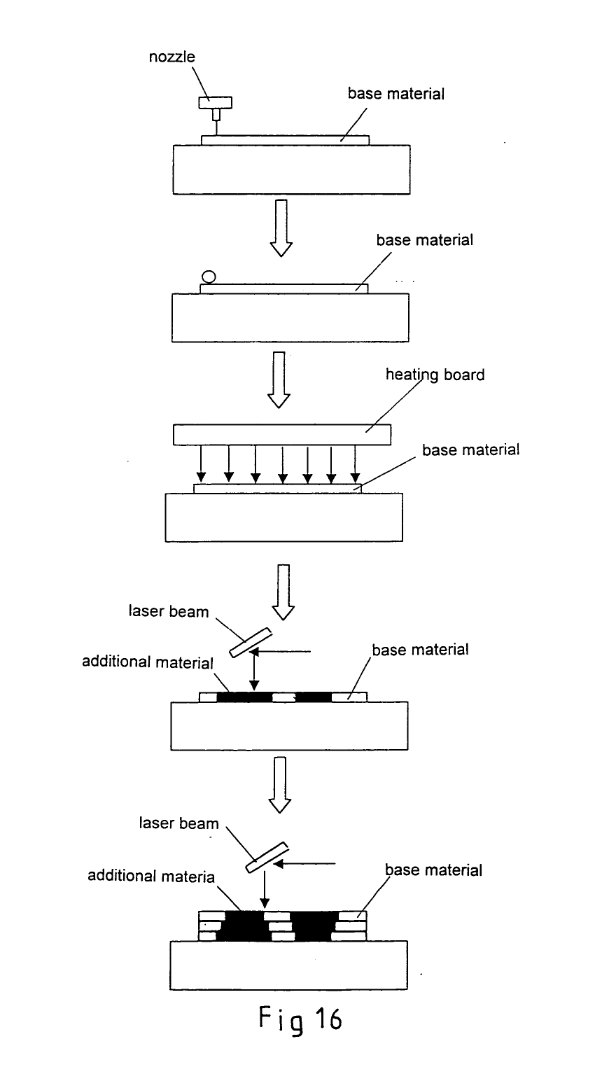

As shown in FIG. 16 which is a tenth embodiment of the method and includes the following steps:
step 1: spreading the base material on a limited area by nozzles and rolling the limited area to be a flat surface by rollers;
step 2: proceeding the first time of physical or chemical change on the selected areas by the ultra violet beams or infra-red beams;
step 3: selectively proceeding the second time of physical or chemical change by laser beam on the selected areas of the base material;
step 4: repeating steps 1-3 pre-determined times which are the number of layers of the two dimensional areas cut from the solid object, and building connection between the layers;
step 5: removing the base material after the first time of physical or chemical change from the result after the second time of physical or chemical change so as to obtain the final prototype.

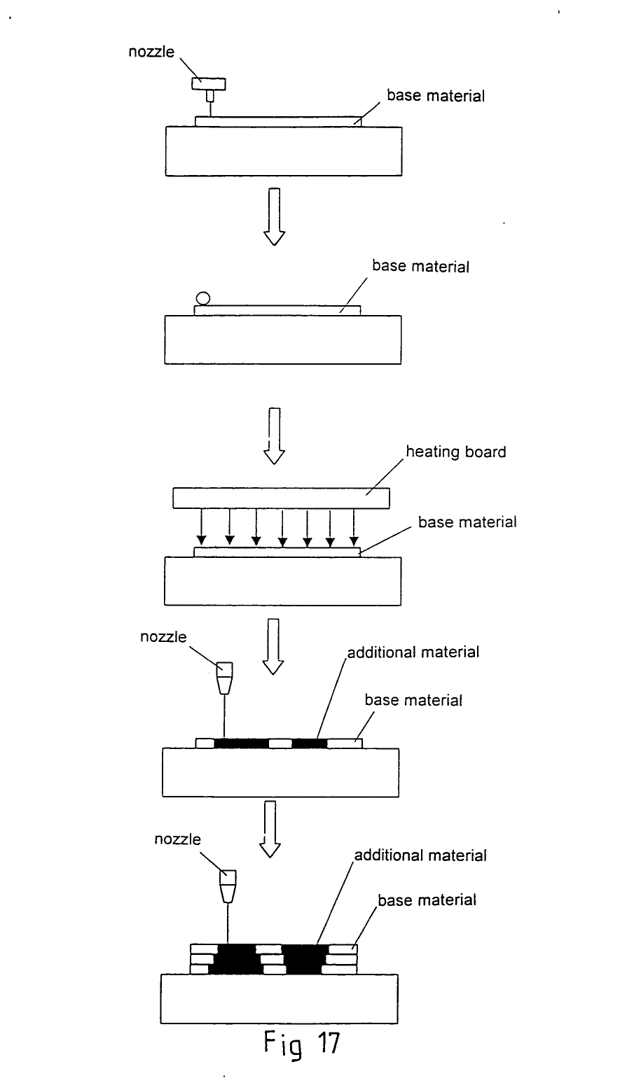

As shown in FIG. 17 which is an eleventh embodiment of the method and includes the following steps:
step 1: spreading the base material on a limited area by nozzles and rolling the limited area to be a flat surface by rollers;
step 2: proceeding the first time of physical or chemical change on the selected areas by the ultra violet beams or infra-red beams;
step 3: adding additional material to the base material so as to proceed the second time of physical or chemical change for the base material;
step 4: repeating steps 1-3 pre-determined times which are the number of layers of the two dimensional areas cut from the solid object, and building connection between the layers;
step 5: removing the base material after the first time of physical or chemical change from the result after the second time of physical or chemical change so as to obtain the final prototype.

Due to the nature of the material, the mechanical strength of the material is not strong enough after the first time of physical or chemical change and is stronger after the first time of physical or chemical change. The less strong material is enclosed by the stronger material. The two types of material can be separated after the object is finished so as to conveniently obtain a three dimensional prototype with less cost, time and higher precision.

While we have shown and described the embodiment in accordance with the present invention, it should be clear to those skilled in the art that further embodiments may be made without departing from the scope of the present invention.

1. A method for forming objects comprising:
step 1: spreading base material on a limited area by nozzles;
step 2: proceeding a first time of physical or chemical change on selected areas by ultra violet beams or infra-red beams and the base material becoming gel-like material;
step 3: selectively proceeding a second time of physical or chemical change by laser beam on the selected areas of the base material and a nature of the gel-like material becoming acceptable;
step 4: repeating steps 1-3 pre-determined times which are the number of layers of the two dimensional areas cut from a solid object, and building connection between the layers;
step 5: removing the base material after the first time of physical or chemical change from a result after the second time of physical or chemical change so as to obtain a final prototype.

2. The method as claimed in claim 1, wherein the base material in step 1 is rolled in the limited area to be a flat surface by rollers.

3. The method as claimed in claim 1, wherein the base material is spread on a limited area by the nozzles and then rolled to be a flat surface by rollers.

4. The method as claimed in claim 1, wherein the base material on the selected areas is proceeded the first time of physical or chemical change by ultra violet beams or infra-red beams.

5. The method as claimed in claim 1, wherein the base material is proceeded the second time of physical or chemical change by adding additional material thereto.
